(19) United States
(12) Patent Application Publication
(10) Pub. No.: US 2025/0142565 A1
(43) Pub. Date: May 1, 2025

(54) METHODS, COMMUNICATIONS DEVICES, AND INFRASTRUCTURE EQUIPMENT

(71) Applicant: Sony Group Corporation, Tokyo (JP)

(72) Inventors: Shin Horng WONG, Basingstoke (GB); Naoki KUSASHIMA, Tokyo (JP); Martin Warwick BEALE, Basingstoke (GB); Yassin Aden AWAD

(73) Assignee: Sony Group Corporation, Tokyo (JP)

(21) Appl. No.: 18/693,529

(22) PCT Filed: Sep. 9, 2022
(86) PCT No.: PCT/EP2022/075143

§ 371 Date: Mar. 20, 2024

(30) Foreign Application Priority Data
Sep. 30, 2021 (EP) 21200352.9

(51) Int. Cl. H04W 72/1273; H04L 25/03; H04W 72/0446

(52) U.S. Cl. CPC H04W 72/1273; H04L 25/03898; H04W 72/0446

(57) ABSTRACT

A method comprising receiving, from a wireless network, a plurality of downlink data signals, determining that a device is to transmit, to the wireless network, for each of the downlink data signals, one of a plurality of feedback signals indicating whether or not the downlink data signal was successfully received, receiving, from the wireless network, a downlink control signal indicating that the device is to select a codebook comprising at least one of the plurality of feedback signals for retransmission to the wireless network, determining, based on the downlink control signal, whether at least one further downlink data signal is scheduled to be received by the device from the wireless network in accordance with a plurality of scheduling parameters indicated by the downlink control signalling, and either selecting the codebook from a first set of codebooks, or selecting the codebook from a second set of codebooks.

### BACKGROUND

### Field of Disclosure

The present disclosure relates to communications devices, infrastructure equipment and methods for the more efficient operation of a communications device in a wireless communications network.

The present application claims the Paris Convention priority of European patent application number EP21200352.9, filed 30 Sep. 2021, and the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Latest generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Future wireless communications networks will be expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for future wireless communications networks, for example those which may be referred to as 5G or new radio (NR) systems/new radio access technology (RAT) systems, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is Enhanced Mobile Broadband (eMBB) services, which are characterised by a high capacity with a requirement to support up to 20 Gb/s. URLLC and eMBB type services therefore represent challenging examples for both LTE type communications systems and 5G/NR communications systems.

The increasing use of different types of network infrastructure equipment and terminal devices associated with different traffic profiles give rise to new challenges for efficiently handling communications in wireless communications systems that need to be addressed.

### SUMMARY OF THE DISCLOSURE

The present disclosure can help address or mitigate at least some of the issues discussed above.

Embodiments of the present technique can provide a method of operating a communications device configured to transmit signals to and/or to receive signals from a wireless communications network via a wireless radio interface provided by the wireless communications network. The method comprises receiving, from the wireless communications network, a plurality of downlink data signals, determining that the communications device is to transmit, to the wireless communications network, for each of the downlink data signals, one of a plurality of feedback signals indicating whether or not the downlink data signal was successfully received, receiving, from the wireless communications network, a downlink control signal indicating that the communications device is to select a codebook comprising at least one of the plurality of feedback signals for retransmission to the wireless communications network, determining, based on the downlink control signal, whether at least one further downlink data signal is scheduled to be received by the communications device from the wireless communications network in accordance with a plurality of scheduling parameters indicated by the downlink control signalling, and either selecting, if the communications device determines that no further downlink data signals are scheduled, the codebook from a first set of codebooks, or selecting, if the communications device determines that the at least one further downlink data signal is scheduled, the codebook from a second set of codebooks, and subsequently retransmitting, to the wireless communications network, the at least one feedback signal defined by the selected codebook.

Embodiments of the present technique, which, in addition to methods of operating communications devices, relate to methods of operating infrastructure equipment, communications devices and infrastructure equipment, circuitry for communications devices and infrastructure equipment, wireless communications systems, computer programs, and computer-readable storage mediums, can allow for more efficient use of radio resources by a communications device operating in a wireless communications network.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 illustrates how multiple Hybrid Automatic Repeat Request Acknowledgement (HARQ-ACK) feedback indications may be multiplexed onto a single Physical Uplink Control Channel (PUCCH);

FIG. 5 illustrates how a PUCCH Resource Indicator may be used to indicate onto which PUCCH HARQ-ACK feedback indications may be multiplexed;

FIG. 6 shows an example of sub-slot based PUCCHs;

FIG. 7 illustrates how multiple HARQ-ACK feedback indications for Semi-Persistent Scheduling (SPS) Physical Downlink Shared Channels (PDSCHs) may be multiplexed onto a single PUCCH per sub-slot;

FIG. 8 shows a part schematic, part message flow diagram representation of a wireless communications system comprising a communications device and an infrastructure equipment in accordance with embodiments of the present technique; and

FIG. 9 shows a flow diagram illustrating a process of communications in a communications system in accordance with embodiments of the present technique.

### DETAILED DESCRIPTION OF THE EMBODIMENTS

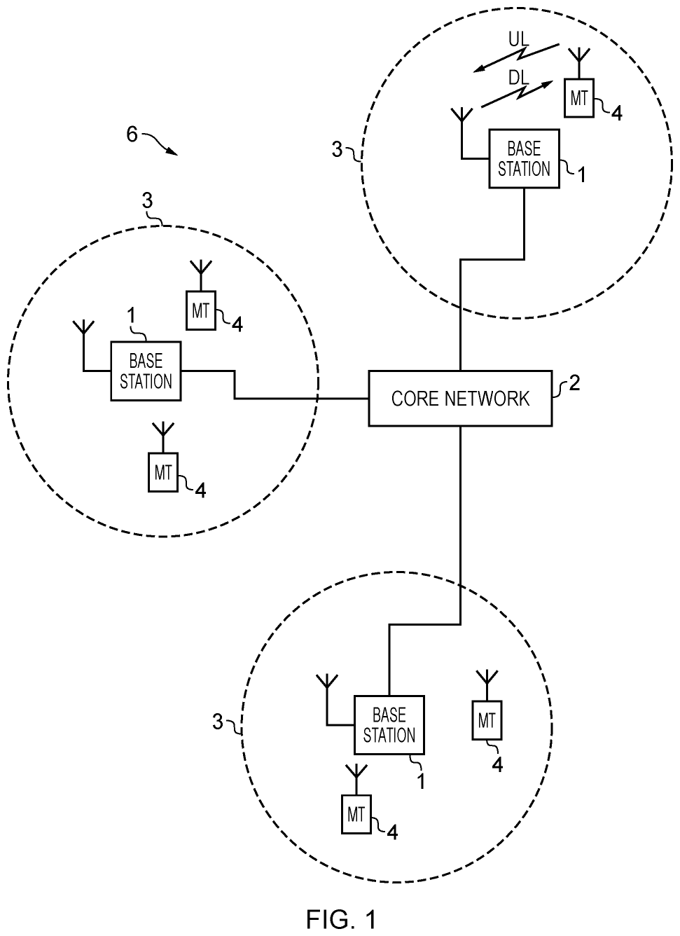

Long Term Evolution Advanced Radio Access Technology (4G) FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [1].

It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

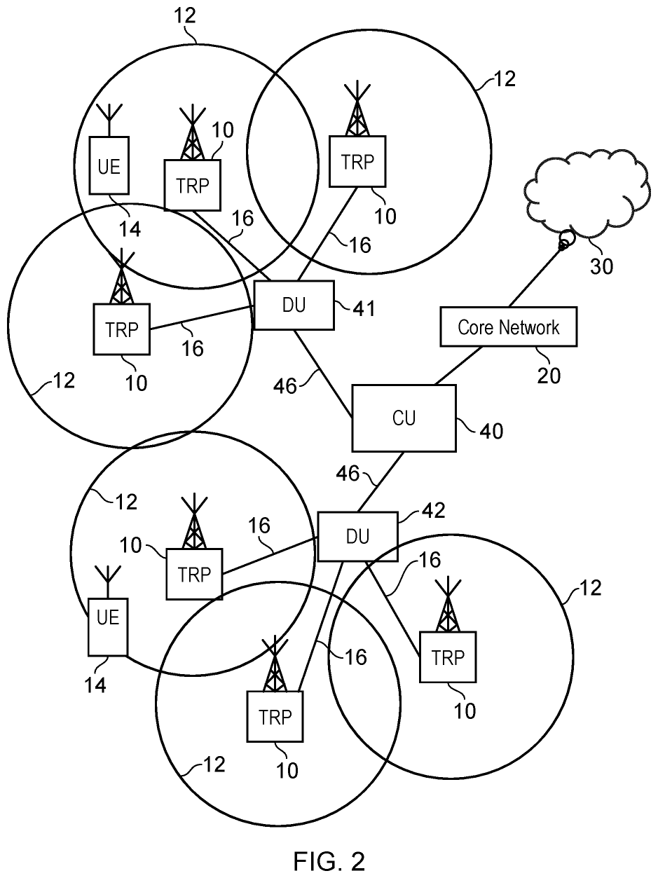

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

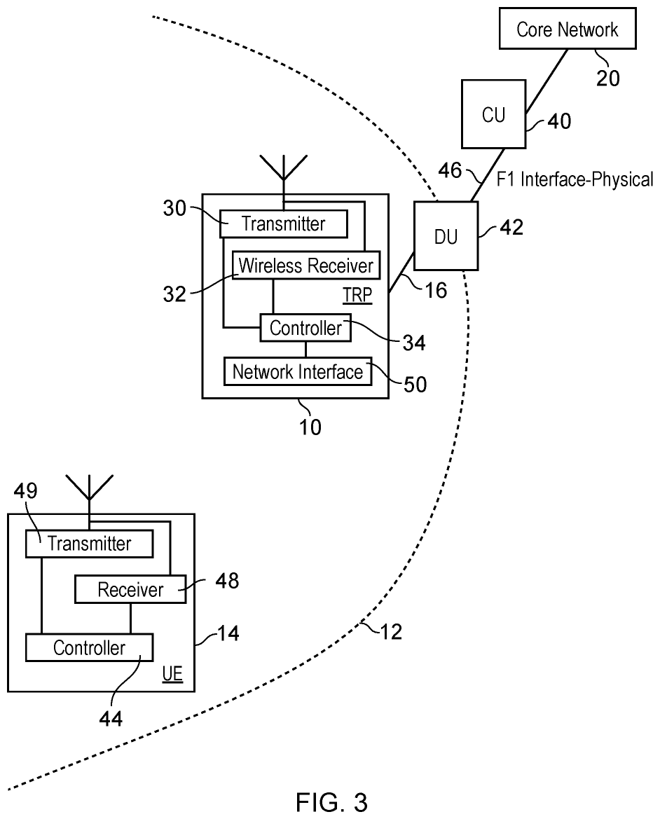

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP10 to the DU 42 and the F1 interface 46 from the DU 42 to the CU 40.

eURLLC and eMBB

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. The requirements for Ultra Reliable and Low Latency Communications (URLLC) services are for one transmission of a 32 byte packet to be transmitted from the radio protocol layer 2/3 SDU ingress point to the radio protocol layer 2/3 SDU egress point of the radio interface within 1 ms with a reliability of 1-10⁻⁵ (99.999%) or higher (99.9999%) [2].

Massive Machine Type Communications (mMTC) is another example of a service which may be supported by NR-based communications networks. In addition, systems may be expected to support further enhancements related to Industrial Internet of Things (IIoT) in order to support services with new requirements of high availability, high reliability, low latency, and in some cases, high-accuracy positioning.

Enhanced URLLC (eURLLC) [3] specifies features that require high reliability and low latency, such as factory automation, transport industry, electrical power distribution, etc. in a 5G system. eURLLC is further enhanced as IIoT-URLLC [4], for which one of the objectives is to enhance UE feedback for Hybrid Automatic Repeat Request Acknowledgements (HARQ-ACK) for Physical Downlink Shared Channel (PDSCH) transmissions.

### PDSCH HARQ-ACK Feedback

In a Dynamic Grant PDSCH (DG-PDSCH), the PDSCH resource is dynamically indicated by the gNB using a DL Grant carried by Downlink Control Information (DCI) in a Physical Downlink Control Channel (PDCCH).

A PDSCH is transmitted using HARQ transmission, where for a PDSCH ending in slot n, the corresponding Physical Uplink Control Channel (PUCCH) carrying the HARQ-ACK is transmitted in slot n+K₁. Here, in Dynamic Grant PDSCH, the value of K₁ is indicated in the field “PDSCH-to-HARQ feedback timing indicator” of the DL Grant (carried by DCI Format 1_0, DCI Format 1_1 or DCI Format 1_2). Multiple (different) PDSCHs can point to the same slot for transmission of their respective HARQ-ACKs, and these HARQ-ACKs (in the same slot) are multiplexed into a single PUCCH. Hence, a PUCCH can contain multiple HARQ-ACKs for multiple PDSCHs.

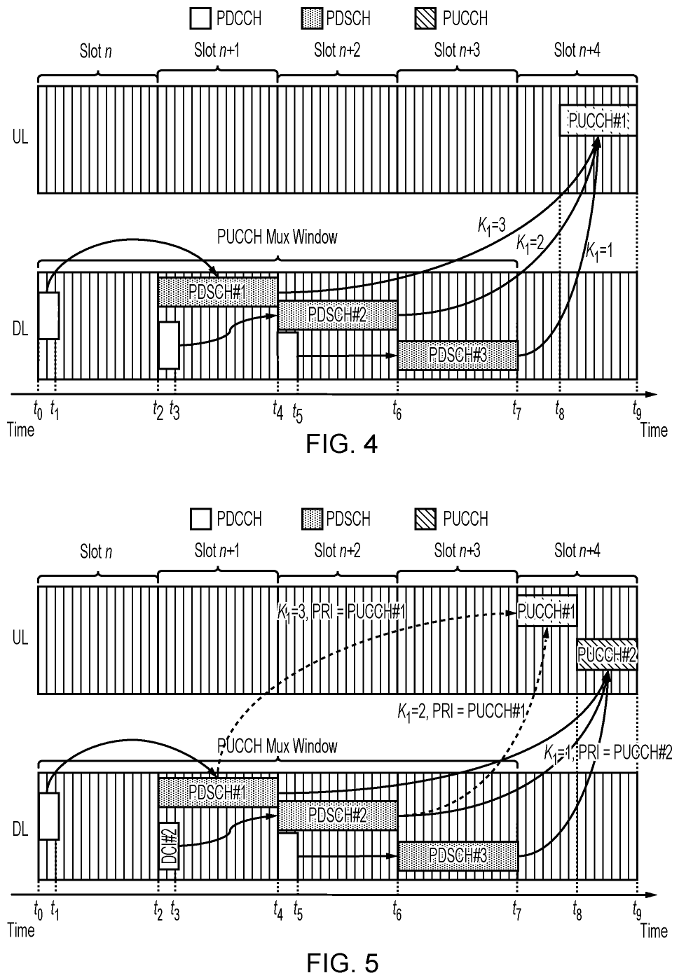

An example of this is shown in FIG. 4, where three DL Grants are transmitted to the UE via DCI #1, DCI #2 and DCI #3 in slot n, n+1 and n+2 respectively. DCI #1, DCI #2 and DCI #3 schedule PDSCH #1, PDSCH #2 and PDSCH #3 respectively. DCI #1, DCI #2 and DCI #3 further indicate K₁=3, K₁=2 and K₁=1 respectively. Since the K₁ values indicate that the HARQ-ACK feedback for PDSCH #1, PDSCH #2 and PDSCH #3 are all to be transmitted in slot n+4, the UE multiplexes all of these HARQ-ACKs into a single PUCCH, i.e. PUCCH #1. The PUCCH Multiplexing Window is a time window where PDSCHs can be multiplexed into that single PUCCH, and the size of the PUCCH multiplexing window depends on the range of K₁ values. In the example in FIG. 4, the PUCCH Multiplexing Window is from Slot n to Slot n+3 (i.e. between time to and time t₇), which means the max K₁ value is 4 slots.

In Rel-15, only one PUCCH per slot is allowed to carry HARQ-ACKs for the same UE, even if the different PUCCHs do not overlap in time. The PUCCH resource is indicated in the “PUCCH Resource Indicator” (PRI) field in the DL Grant. Each DL Grant may indicate a different PUCCH resource, but the UE will follow the PRI indicated in the last PDSCH in the PUCCH Multiplexing Window since the UE only knows the total number of HARQ-ACK bits after the last PDSCH is received.

An example of this is shown in FIG. 5, where DCI #1 and DCI #2 indicate PUCCH #1 for the HARQ-ACKs corresponding to PDSCH #1 and PDSCH #2, but DCI #3 indicates PUCCH #2 for the HARQ-ACK corresponding to PDSCH #3. Here, PUCCH #1 and PUCCH #2 do not overlap in time. Since DCI #3 schedules the last PDSCH, i.e. PDSCH #3, in the Multiplexing Window, the UE will use PUCCH #2 to carry the HARQ-ACKs for PDSCH #1, PDSCH #2 and PDSCH #3. It should be noted here that a PUCCH carrying other UCI such as SR (Scheduling Request) can be transmitted separately to a PUCCH carrying HARQ-ACKs within the same slot if they do not overlap in time.

In Rel-16 eURLLC, sub-slot PUCCH is introduced for carrying HARQ-ACKs for URLLC PDSCHs. Sub-slot based PUCCHs allow more than one PUCCH carrying HARQ-ACKs to be transmitted within a slot. This gives more opportunity for PUCCHs carrying HARQ-ACKs for PDSCHs to be transmitted within a slot, thereby reducing latency for HARQ-ACK feedback. In a sub-slot based PUCCH, the granularity of the K₁ parameter (i.e. the time difference between the end of a PDSCH and the start of its corresponding PUCCH) is in units of sub-slots instead of units of slots, where the sub-slot size can be either two symbols or seven symbols.

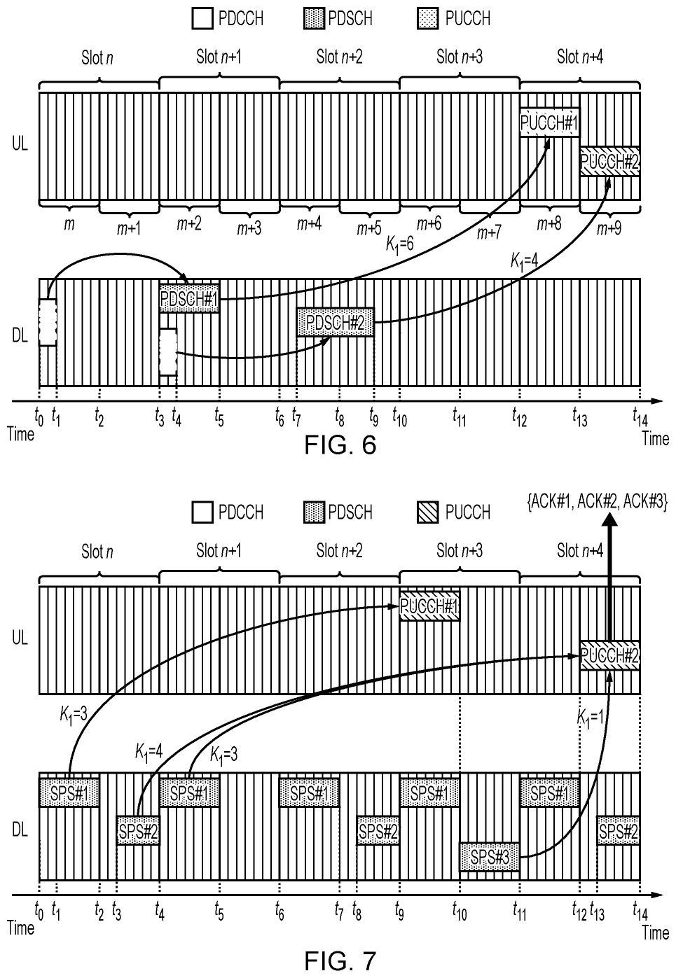

An example of this is shown in FIG. 6, where the sub-slot size equals seven symbols (i.e. half a slot) and the sub-slots are labelled as m, m+1, m+2, etc. PDSCH #1 is transmitted in slot n+1 but for sub-slot based HARQ-ACK PUCCH, it is considered to be transmitted in sub-slot m+2 and here K₁=6 which means that the corresponding HARQ-ACK is in sub-slot m+2+K₁=m+8. PDSCH #2 is transmitted in slot n+2 but occupies sub-slots m+4 and m+5. The reference for K₁ is relative to the sub-slot where the PDSCH ends, and in this case PDSCH #2 ends in sub-slot m+5. The DL Grant in DCI #2 that schedules PDSCH #2 indicates K₁=4, which schedules a PUCCH for its HARQ-ACK at sub-slot m+5+K₁=sub-slot m+9.

### Semi-Persistent Scheduling (SPS)

As is well understood by those skilled in the art, a gNB uses a PDSCH for downlink data transmission to a UE. The PDSCH resources used for the transmission of the PDSCH can be scheduled by a gNB either dynamically, or through the allocation of Semi-Persistent Scheduling (SPS) resources.

Similarly to the use of Configured Grants (CGs) in the uplink, the use of SPS in the downlink reduces latency, particularly for regular and periodic traffic. The gNB is required to explicitly activate and deactivate SPS resources when it determines they may be required. These SPS resources are typically configured via Radio Resource Control (RRC) signalling, and occur periodically where each SPS PDSCH occasion has a pre-configured and fixed duration. This allows the gNB to schedule traffic that has a known periodicity and packet size. The gNB may or may not transmit any PDSCH in any given SPS PDSCH occasion, and so the UE is required to monitor each SPS PDSCH occasion for a potential PDSCH transmission.

In Rel-15 the UE can only be configured with one SPS PDSCH and this SPS PDSCH is activated using an activation DCI (Format 10 or 1_1) with the Cyclic Redundancy Code (CRC) scrambled with a Configured Scheduling Radio Network Temporary Identifier (CS-RNTI). Once an SPS PDSCH is activated, the UE will monitor for a potential PDSCH in each SPS PDSCH occasion of the SPS PDSCH configuration without the need for any DL Grant until the SPS PDSCH is deactivated. Deactivation of the SPS PDSCH is indicated via a deactivation DCI scrambled with CS-RNTI. The UE provides a HARQ-ACK feedback for the deactivation DCI, but no HARQ-ACK feedback is provided for an activation DCI.

Similar to DG-PDSCH, the slot containing the PUCCH resource for HARQ-ACK corresponding to SPS PDSCH is indicated using the K₁ value in the field “PDSCH-to-HARQ_feedback timing indicator” of the activation DCI. Since a dynamic grant is not used for SPS PDSCH, this K₁ value is applied for every SPS PDSCH occasion, and can only be updated after it has been deactivated and re-activated using another activation DCI with a different K₁ value.

Since there is only one SPS PDSCH, PUCCH Format 0 or 1 is used to carry the HARQ-ACK feedback. If the PUCCH collides with a PUCCH carrying HARQ-ACK feedback for a DG-PDSCH, the HARQ-ACK for SPS PDSCH is multiplexed into the PUCCH corresponding to the DG-PDSCH.

In Rel-16 the UE can be configured with up to eight SPS PDSCHs, where each SPS PDSCH has an SPS Configuration Index that is RRC configured. Each SPS PDSCH is individually activated using a DCI (Format 10, 1_1, and 1_2) with the CRC scrambled with CS-RNTI, where the DCI indicates the SPS Configuration Index of the SPS PDSCH to be activated. However, multiple SPS PDSCHs can be deactivated using a single deactivation DCI. Similar to Rel-15, the UE provides a HARQ-ACK feedback for the deactivation DCI, but does not provide one for the activation DCI.

The slot or sub-slot containing the PUCCH resource for HARQ-ACK feedback corresponding to an SPS PDSCH occasion is determined using the K₁ value indicated in the activation DCI. Since each SPS PDSCH configuration is individually activated, different SPS PDSCH can be indicated with different K₁ values.

Since different K₁ values can be used for different SPS PDSCH configurations, it is possible that the HARQ-ACK for multiple SPS PDSCHs point to the same slot or sub-slot, and in such a scenario, these HARQ-ACKs are multiplexed into a single PUCCH. For multiple SPS PDSCH configurations, PUCCH Format 2, 3, and 4 (in addition to PUCCH Format 0 and 1) can be used to carry multiple HARQ-ACKs for SPS PDSCH. Here, the HARQ-ACKs in the PUCCH are sorted in ascending order according to the DL slot for each of the SPS PDSCH Configuration Indices, and then sorted in ascending order of SPS PDSCH Configuration Index. It should be noted here that since typically the K₁ value is fixed per SPS PDSCH then it is unlikely to have two or more SPS PDSCH with the same index being multiplexed into a PUCCH.

An example of this is shown in FIG. 7, where a UE is configured with three SPS PDSCHs labelled as SPS #1, SPS #2 and SPS #3 with different periodicities that are RRC configured with SPS Configuration Index 1, 2 and 3 respectively. SPS #1, SPS #2 and SPS #3 are activated with K₁=3, K₁=4 and K₁=1 respectively. These K₁ values result in the PUCCH for HARQ-ACK feedback corresponding to SPS #2 in Slot n, SPS #1 in Slot n+1 and SPS #3 in Slot n+3 being in the same slot, i.e. carried by PUCCH #2 in Slot n+4. PUCCH #2 therefore provides 3 HARQ-ACKs labelled as {ACK #1, ACK #2, ACK #3} for SPS #1, SPS #2 and SPS #3 respectively according to their SPS PDSCH Configuration Indices (it can be seen that, in this example, there is only one unique SPS PDSCH per DL slot that has HARQ-ACK multiplexed into PUCCH #2).

In Rel-16, when the PUCCH for an SPS PDSCH collides with the PUCCH for a DG-PDSCH, their HARQ-ACKs are multiplexed, where the SPS PDSCH HARQ-ACKs are appended after those for DG-PDSCH, if they have the same priority. Otherwise, one of the PUCCHs is prioritised.

### Type 3 HARQ-ACK Codebook

The Type 3 HARQ-ACK Codebook (Type 3 CB) was introduced for 5G New Radio Unlicensed (NR-U) in Rel-16 to trigger a UE to retransmit its HARQ-ACKs due to unsuccessful PUCCH or Physical Uplink Shared Channel (PUSCH) HARQ-ACK transmission(s) as a result of a Listen Before Talk (LBT) failure. A Type 3 HARQ-ACK Codebook is triggered using the 1-bit DCI field “One-shot HARQ-ACK request” (1-shot) in DCI Format 1_1, which indicates to the UE that it is to transmit PDSCH HARQ-ACK feedbacks for all configured HARQ Process Numbers (HPN) across all Component Carriers (CC), regardless of whether any of these HARQ-ACKs had been transmitted previously, whether any of the HARQ-ACKs correspond to an unscheduled PDSCH, or whether the UE failed to transmit any of the HARQ-ACKs due to failed LBT attempt(s).

Since Type 3 CB is triggered using a DL Grant, the DL Grant can schedule a PDSCH whilst triggering the Type 3 CB, thus ensuring that a signalling saving may be achieved. However, the gNB may not actually have any downlink data to transmit to the UE, instead just requiring the UE to retransmit the HARQ-ACKs. Therefore, the DL Grant uses the “Frequency Domain Resource Assignment” (FDRA) DCI field to implicitly indicate whether a PDSCH is scheduled or not. The FDRA field is used to schedule frequency resources, i.e. Resource Blocks (RB), for the UE's PDSCH. Here, if the 1-shot DCI field is “1”, it triggers the Type 3 CB, and if the FDRA DCI field is set to all “0”s or all “1”s, then this indicates that no PDSCH is scheduled. Otherwise, any other FDRA value (i.e. a mixture of both “0”s and “1”s) indicates that the PDSCH is scheduled with the RBs as indicated by these “0”s and “1”s in the FDRA field.

A PUCCH or PUSCH carrying HARQ-ACKs for PDSCHs may be cancelled due to intra-UE layer 1 (L1) prioritisation when it collides with a higher priority PUCCH or PUSCH. A UE's PUCCH or PUSCH transmission can also be cancelled by an UL Cancellation Indicator due to uplink inter-UE prioritisation; that is, a lower priority uplink transmission from one UE collides with a higher priority uplink transmission from another UE, and the UL Cancellation Indicator therefore cancels the transmission for the UE with the lower priority uplink transmission. In Time Division Duplexing (TDD), a UE's PUCCH for SPS PDSCH can also be cancelled if it collides with DL symbols or invalid symbols. A cancelled PUCCH that contains multiple HARQ-ACKs may lead to the retransmission of multiple PDSCHs, since the gNB is not aware of the decoding status of these PDSCHs. This would therefore lead to inefficient use of resources, especially if the UE had successfully decoded most of these PDSCHs. Hence in Rel-17 URLLC, a more optimised mechanism to retransmit HARQ-ACKs was introduced.

While the Rel-16 Type 3 CB can be used for HARQ-ACK retransmission as described above, this consumes a lot of resources and has a very high overhead since it retransmits HARQ-ACKs for all HARQ Processes across all CCs. Recognising this, 3GPP introduced an enhanced Type 3 HARQ-ACK Codebook (e-Type 3 CB) that can be RRC-configured to have a smaller size, where this e-Type 3 CB feeds back a subset of HARQ Process Numbers (HPN) for a subset of CCs. However, since the size of the e-Type 3 CB is semi-statically (RRC) configured, this will still lead to high overheads since the gNB cannot predict which HPNs of a CC would be dropped and thus will need to be retransmitted. In order to adapt the e-Type 3 CB size to the dynamically changing set of HARQ-ACKs that require retransmission, it has been proposed that the UE can be RRC-configured with multiple e-Type 3 CBs of different sizes, each relating to different subsets of HPN/CC, and the gNB can dynamically indicate one of these multiple e-Type 3 CBs using the triggering DCI (DL Grant) depending on the HARQ-ACKs that require retransmission. The following options were proposed in [5] for the dynamic selection of an e-Type 3 CB out of M_{CB} configured e-Type 3 CBs:
Option 1: Introduce a new DCI field to indicate one of M_{CB} e-Type 3 CBs and also to indicate that e-Type 3 CB is not triggered. The size of this new DCI field is therefore ┌log₂(M_{CB}+1)┐; or
Option 2: Use the 1-shot DCI field to trigger the e-Type 3 CB, and:
   If M_{CB}=1, the triggering DL Grant DCI can also schedule a PDSCH; or
   If M_{CB}>1, the triggering DL Grant DCI cannot schedule any PDSCH but instead, the existing DCI fields that are used for scheduling PDSCH are reinterpreted to indicate the selection of a e-Type 3 CB out of M_{CB} e-Type 3 CBs.

Option 1 will increase the DCI size by adding a new field, which is typically not favourable for URLLC since it requires more resources to maintain the reliability requirement of the PDCCH carrying a bigger DCI. However, the benefit of Option 1 is that it can be used to both trigger an e-Type 3 CB and schedule a PDSCH in a single DCI. Since Option 2 reuses existing DCI fields to select an e-Type 3 CB for M_{CB}>1, it has been suggested that it does not increase the size of the DCI. However, it is argued that this may lead to a doubling of the DCI resource since preventing the gNB from scheduling a PDSCH whilst triggering a e-Type 3 CB would require the gNB to use a further DCI to transmit another DL Grant in order to schedule a PDSCH, if one is to be scheduled. Furthermore, sending a separate DCI may lead to an increase in latency in the PDSCH transmission.

Hence, a technical problem to solve is how to allow the gNB to trigger one of multiple e-Type 3 CBs, while also allowing for the optional scheduling of a PDSCH in the same DCI, with a minimal or no increase in the size of the triggering DCI. Embodiments of the present disclosure provide solutions to such a technical problem.

PDSCH Scheduling & e-Type 3 HARQ-ACK Codebook Selection in a Downlink Grant

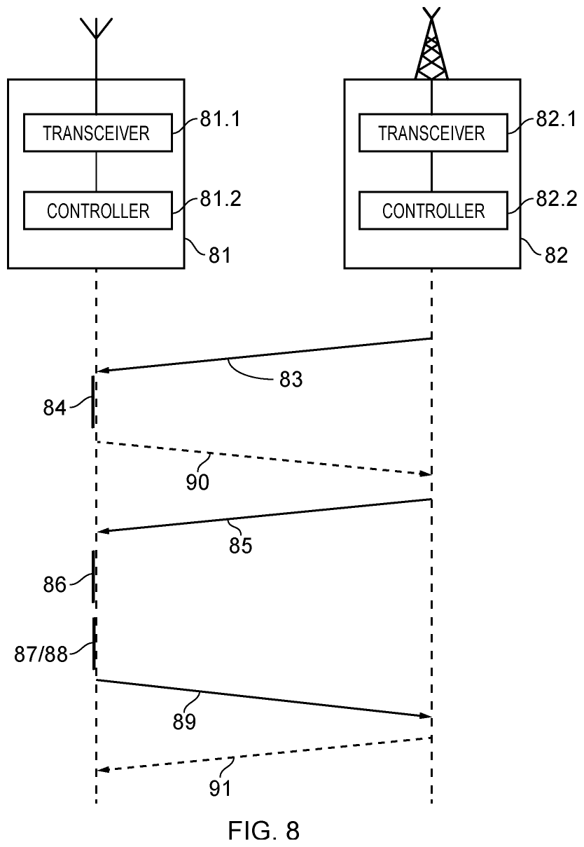

FIG. 8 shows a part schematic, part message flow diagram representation of a first wireless communications system comprising a communications device 81 and an infrastructure equipment 82 in accordance with at least some embodiments of the present technique. The communications device 81 is configured to transmit signals to and/or receive signals from the wireless communications network, for example, to and from the infrastructure equipment 82. Specifically, the communications device 81 may be configured to transmit data to and/or receive data from the wireless communications network (e.g. to/from the infrastructure equipment 82) via a wireless radio interface provided by the wireless communications network (e.g. the Uu interface between the communications device 81 and the Radio Access Network (RAN), which includes the infrastructure equipment 82). The communications device 81 and the infrastructure equipment 82 each comprise a transceiver (or transceiver circuitry) 81.1, 82.1, and a controller (or controller circuitry) 81.2, 82.2. Each of the controllers 81.2, 82.2 may be, for example, a microprocessor, a CPU, or a dedicated chipset, etc.

As shown in the example of FIG. 8, the transceiver circuitry 81.1 and the controller circuitry 81.2 of the communications device 81 are configured in combination to receive 83, from the wireless communications network (e.g. from the infrastructure equipment 82), a plurality of downlink data signals (e.g. PDSCHs), to determine 84 that the communications device is to transmit 90, to the wireless communications network (e.g. to the infrastructure equipment 82), for each of the downlink data signals, one of a plurality of feedback signals (where the plurality of available feedback signals may be different (e.g. higher) than the number of the plurality of received downlink data signals) indicating whether or not the downlink data signal was successfully received (such feedback signals are then transmitted 90 by the communications device 81, unless it determines not to, for example in response to receiving an uplink cancellation indicator (UL CI)), to receive 85, from the wireless communications network (e.g. from the infrastructure equipment 82), a downlink control signal indicating that the communications device 81 is to select a codebook comprising at least one of the plurality of feedback signals for retransmission to the wireless communications network (e.g. to the infrastructure equipment 82), to determine 86, based on the downlink control signal, whether at least one further downlink data signal (e.g. PDSCH(s)) is scheduled to be received 91 by the communications device 81 from the wireless communications network (e.g. from the infrastructure equipment 82) in accordance with a plurality of scheduling parameters indicated by the downlink control signalling, and either to select 87, if the communications device 81 determines that no further downlink data signals are scheduled, the codebook from a first set of codebooks, or to select 88, if the communications device 81 determines that the at least one further downlink data signal is scheduled, the codebook from a second set of codebooks, and subsequently to retransmit 89, to the wireless communications network (e.g. to the infrastructure equipment 82), the at least one feedback signal defined by the selected codebook. The downlink control signalling may also indicate (time and frequency) resources of the wireless radio interface within which the at least one further downlink data signal is to be received 91 by the communications device 81.

Essentially, embodiments of the present technique propose that two sets of e-Type 3 CBs are defined, where a first set of e-Type 3 CBs has a size of M_{CB} and a second set of e-Type 3 CBs has a size of N_{CB}. When the e-Type 3 CB is triggered, the set of e-Type 3 CBs that the UE uses for the selection of an e-Type 3 CB is determined as follows:
If the gNB does not schedule any PDSCH(s), then the first set of e-Type 3 CBs is used, where the gNB indicates one of M_{CB} e-Type 3 CBs for HARQ-ACK retransmission; or
If the gNB schedules one or more PDSCHs, then the second set of e-Type 3 CBs is used, where the gNB indicates one of N_{CB} e-Type 3 CBs for HARQ-ACK retransmission.

Herein, the DL Grant (i.e. the downlink control signal) that triggers an e-Type 3 CB is also referred to as the triggering DCI. Those skilled in the art would appreciate that although embodiments of the present technique are applicable to e-Type 3 CBs in order to solve the technical problem described above, of how to allow the gNB to trigger one of multiple e-Type 3 CBs, while also allowing for the optional scheduling of a PDSCH in the same DCI, with a minimal or no increase in the size of the triggering DCI, other ways of indicating HARQ-ACK retransmission (or indeed retransmission of any appropriate feedback signals) are anticipated by embodiments of the present disclosure as defined herein, including any appropriate ways of signalling sets of HARQ-ACKs/feedback signals that may not necessarily be codebooks at all.

In some arrangements of embodiments of the present technique, N_{CB}<M_{CB}. In other words, the first set of codebooks comprises a greater (or equal) number of codebooks than the second set of codebooks. This recognises that the triggering DCI size is the same whether the gNB schedules a PDSCH or not, and so if the gNB schedules a PDSCH, it requires more DCI bits for the scheduling parameters (e.g. time & frequency resources, MCS, HPN, etc.) of the PDSCH, and has fewer bits left to indicate one of the e-Type 3 CBs. Hence, a smaller set size in the second set of e-Type 3 CBs is beneficial to reduce the number of bits needed for e-Type 3 CB selection when the gNB is scheduling a PDSCH compared to when the gNB is not scheduling a PDSCH, when more bits are available to indicate an e-Type 3 CB from a larger set size of e-Type 3 CBs, as some of the existing DCI fields used for PDSCH scheduling can be reused for e-Type 3 CB selection. In some implementations of arrangements of embodiments of the present technique, the second set of e-Type 3 CBs may be a subset of the first set of e-Type 3 CBs.

In another arrangement of embodiments of the present technique, the e-Type 3 CB is triggered using a 1-bit indicator in the triggering DCI. In an implementation this 1-bit indicator is the 1-shot indicator. In other words, the downlink control signal comprises a bit that has a value that indicates that the communications device is to select the codebook and to retransmit the at least one feedback signal defined by the selected codebook.

In another arrangement of embodiments of the present technique, if the gNB triggers an e-Type 3 CB, it indicates using the FDRA DCI field whether it is also scheduling one or more PDSCH or not. In other words, the downlink control signal comprises a bit field that indicates whether or not the at least one further downlink data signal is scheduled. That is, the e-Type 3 CB is triggered in the triggering DCI, and:
If the FDRA field indicates all “0”s or all “1”s, then the first set of e-Type 3 CBs is used with a set size of M_{CB} (in other words, if all the bits of the bit field are the same, the bit field indicates that no further downlink data signals are scheduled and therefore that the selected codebook is to be selected from the first set of codebooks); or
Otherwise (if the FDRA field is not all “0”s and not all “1”s) then the second set of e-Type 3 CBs is used with a set size of N_{CB} (in other words, if the bits of the bit field are not all the same, the bit field indicates resources of the wireless radio interface in which the at least one further downlink data signal is to scheduled, and therefore that the selected codebook should be taken from the second set of codebooks).

It should be appreciated by those skilled in the art that any suitable triggering methods are suitable and appropriate for arrangements of embodiments of the present technique as disclosed herein, and such triggering does not need to be done via an explicit 1-shot DCI field. Furthermore, those skilled in the art would appreciate that other methods of indicating whether or not a PDSCH is scheduled are suitable and appropriate for arrangements of embodiments of the present technique as disclosed herein, and such an indication does not need to be conveyed via the FDRA field as described in the example above.

In some arrangements of embodiments of the present technique, N_{CB}=1. That is, the gNB configures a default e-Type 3 CB. In other words, the second set of codebooks comprises only a single codebook, the single codebook being a default codebook. If the gNB schedules a PDSCH and triggers an e-Type 3 CB, then the UE will always select this default e-Type 3 CB. It should be appreciated that using a default (i.e. N_{CB}=1) e-Type 3 CB does not require any additional bits for e-Type 3 CB selection. This default e-Type 3 CB may be unique to the second set, of which it is the only e-Type 3 CB. Such a default e-Type 3 CB may for example be much larger than any of the CBs in the first set, which are smaller and are designed for more specific cases while the default CB in the second set may be used more generally.

In an arrangement of embodiments of the present technique, the default e-Type 3 CB is one of the M_{CB} e-Type 3 CBs, in addition to being the only e-Type 3 CB in the second set with size N_{CB}=1. In other words, the first set of codebooks comprises a plurality of codebooks, wherein one of the plurality of codebooks is the default codebook, and therefore the default codebook forms part of both the first set of codebooks and the second set of codebooks.

In another arrangement of embodiments of the present technique, the default e-Type 3 CB (i.e. where N_{CB}=1) is the Rel-16 Type 3 CB described above. In other words, the default codebook comprises all of the plurality of feedback signals. Since the legacy Type 3 CB retransmits all HARQ-ACKs, it therefore will cause retransmission of any arrangement of targeted HARQ-ACKs required, and thus as a default option will ensure that no retransmissions are missed.

In another arrangement of embodiments of the present technique, the default e-Type 3 CB (i.e. where N_{CB}=1) is the e-Type 3 CB with the largest size in the first set of e-Type 3 CBs. In other words, the default codebook comprises a higher number of feedback signals than the other codebooks of the first set of codebooks. This recognises that the e-Type 3 CB with the largest size has a higher chance of retransmitting the targeted HARQ-ACKs (e.g. HARQ-ACKs that are dropped) as it will omit fewer HARQ-ACKs from retransmission.

For example, assuming that there is only one component carrier (CC) and M_{CB}=4, configured e-Type 3 CBs may be as shown in Table I below:

TABLE I
Example first set of e-Type 3 CBs for 1 CC

| e-Type 3 | |
|---|---|
| CB Index | HARQ Process Number (HPN) |
| 0 | {0, 5, 10, 15} |
| 1 | {0, 2, 4, 6, 8, 10, 12, 14} |
| 2 | {1, 3, 5, 7, 9, 11, 13, 15} |
| 3 | {0, 1, 2, 3, 4, 5, 6, 7, 8, 9, 10} |

Then, the default e-Type 3 CB according to this arrangement is the codebook with index 3, since it has the largest size, i.e. it retransmits the most HARQ-ACKs.

In another arrangement of embodiments of the present technique, the default e-Type 3 CB (i.e. where N_{CB}=1) is the first indexed e-Type 3 CB in the first set of e-Type 3 CBs. In other words, each of the plurality of codebooks of the first set of codebooks are associated with a unique index value, and wherein the default codebook is associated with a first of the unique index values. Using the same example as that shown in Table I, the default e-Type 3 CB here is the codebook with index 0 since that is the first index of the first codebook of the (first) set of e-Type 3 CBs. In some implementations, this may be the largest codebook rather than the smallest, or may be neither largest nor smallest. In other implementations, any specific (first, last, or other) index may be designated as the default codebook.

For arrangements of embodiments of the present disclosure where N_{CB}>1, the gNB needs a method to indicate to the UE which e-Type 3 CB (from among the N_{CB} codebooks of the second set of codebooks) to use. In other words, the downlink control signal indicates that the at least one further downlink data signal (i.e. PDSCH(s)) is scheduled, and hence that the selected codebook is to be chosen from the second set of codebooks, and wherein the second set of codebooks comprises a plurality of codebooks. The downlink control signal may provide a further indication of which e-Type 3 CB from the second set of e-Type 3 CBs is to be used. The below implementations provide manners in which this indication may be supported.

In an arrangement of embodiments of the present technique where N_{CB}>1 and an e-Type 3 CB is triggered with scheduled PDSCH(s) by the triggering DCI, the UE selects one of N_{CB} e-Type 3 CBs based on the conditions of the HARQ-ACK as described in co-pending European patent application number EP21188964.7 [6], the contents of which are hereby incorporated by reference. In other words, the selected codebook is selected by the communications device from among the plurality of codebooks based on at least one condition of the plurality of feedback signals. Such conditions may relate to the HARQ-ACK(s) that are cancelled (e.g. due to intra-UE L1 prioritisation or an UL cancellation indicator) and these conditions may include, but are not limited to, a number of cancelled HARQ-ACK(s), a HARQ Process Number (HPN) of the cancelled HARQ-ACK(s), CCs containing cancelled HARQ-ACK(s), a scheduling time order of the PDSCH(s) to which the cancelled HARQ-ACK(s) are associated, and a layer 1 priority of the cancelled HARQ-ACK(s). This arrangement therefore does not require any additional overhead in the triggering DCI, since the correspondence between such N_{CB} e-Type 3 CBs and HARQ-ACK conditions may be fixed in the specifications and known to both the UE and the network.

In some arrangements of embodiments of the present technique where N_{CB}>1 and an e-Type 3 CB is triggered with scheduled PDSCH(s) by the triggering DCI, some of the scheduling parameters of the PDSCH may be reduced to a smaller set of values. A smaller set of possible PDSCH scheduling parameters would require fewer DCI bits, and the unused bits can then be utilised to indicate one of N_{CB} e-Type 3 CBs. In other words, the downlink control signal comprises a plurality of groups of one or more bits, each group of bits indicating one of the plurality of scheduling parameters in accordance with which the at least one further downlink data signal is scheduled to be received by the communications device, and wherein the selected codebook is selected by the communications device from among the plurality of codebooks based on a value of at least one bit of one of the groups of bits, the scheduling parameter indicated by the one of the groups of bits therefore being indicated by a reduced number of bits. Such arrangements of embodiments of the present technique do reduce the flexibility of PDSCH scheduling, but hold significant advantages over option 2 as proposed in [5] and as described above, since there is no loss in terms of signalling overheads or PDSCH latency as a single (the triggering) DCI may still be used.

In one such arrangement of the present technique, the reduced PDSCH scheduling parameter is the MCS (Modulation and Coding Scheme). In other words, the scheduling parameter indicated by the reduced number of bits is a modulation and coding scheme. The MCS field is 5 bits indicating one of 32 MCS for the PDSCH. In an example, the MCS field can be reduced to fewer bits, e.g. 3 bits which can indicate one of 8 MCS, thereby allowing 2 bits to be used to signal an e-Type 3 CB, giving a possible N_{CB}=4 e-Type 3 CBs that can be indicated. Both the reduced set of MCS and the number of bits that can be reduced can be RRC configured or fixed in the specifications.

In another such arrangement of embodiments of the present technique, the reduced PDSCH scheduling parameter is the HARQ Process Number (HPN). In other words, the scheduling parameter indicated by the reduced number of bits is a Hybrid Automatic Repeat Request, HARQ, process number. The HPN field is 4 bits and so can be reduced for example to 2 bits or 3 bits providing up to 2 bits for indication of an e-Type 3 CB. Both the reduced set of HPN and the number of bits that can be reduced can be RRC configured or fixed in the specifications.

In another such arrangement of embodiments of the present technique, the reduced PDSCH scheduling parameter is the Time Domain Resource Assignment (TDRA). In other words, the scheduling parameter indicated by the reduced number of bits is a Time Domain Resource Assignment, TDRA. The TDRA can be configured to 4 bits, where it points to one of a maximum of 16 possible time resource assignments. Both the reduced set of TDRA and the number of bits that can be reduced can be RRC configured or fixed in the specifications.

In another such arrangement of embodiments of the present technique, the reduced TDRA is implemented where some of the entries in the TDRA table also indicate an e-Type 3 CB. In other words, the selected codebook is selected by the communications device from among the plurality of codebooks based on an index value of a TDRA indicated from among a plurality of TDRAs that are each associated with a unique index value, the TDRA being one of the plurality of scheduling parameters in accordance with which the at least one further downlink data signal is scheduled to be received by the communications device.

An example is discussed with reference to Table II below, where N_{CB}=2 and the TDRA field is 2 bits, giving a TDRA table with four entries. Here, two of the TDRA entries with Indexes of “10” and “11” indicate e-Type 3 CB #1 and e-Type 3 CB #2 respectively, in addition to the TDRA parameters, e.g. Symbol Offset S and PDSCH Duration L. It should be appreciated that although in this example the TDRA parameters that indicates one of N_{CB} e-Type 3 CBs have the same S and L parameters, this arrangement is not restricted in this manner, and as such the TDRA entries indicating an e-Type 3 CB can indicate different TDRA parameters. It should also be noted that in addition to S and L parameters, there are other TDRA parameters, such as PDSCH mapping type, which is not shown in the example in Table II in order to simplify explanation.

TABLE II
TDRA entries to indicate e-Type 3 CB

| TDRA | Symbol | PDSCH | e-Type 3 |
|---|---|---|---|
| Index | Offset, S | Duration, L | CB Index |
| 00 | 3 | 10 | N/A |
| 01 | 4 | 8 | N/A |
| 10 | 2 | 8 | 0 |
| 11 | 2 | 8 | 1 |

In another arrangement of embodiments of the present technique, the UE may be configured with two TDRA tables, where a first TDRA table is used when the e-Type 3 CB is not triggered and the second TDRA table is used when the e-Type 3 CB is triggered. The second TDRA table will therefore have an additional column, i.e. another parameter for each TDRA index that indicates which one of N_{CB} e-Type 3 CBs to use. In other words, the selected codebook is selected by the communications device from among the plurality of codebooks based on a TDRA being indicated from among a first plurality of TDRAs that are indicated when the communications device is not required to retransmit any feedback signals, the first plurality of TDRAs being different to a second plurality of TDRAs that are indicated when the communications device is required to retransmit one or more feedback signals, the TDRA being one of the plurality of scheduling parameters in accordance with which the at least one further downlink data signal is scheduled to be received by the communications device.

An example of a first TDRA table and a second TDRA table are shown below in Tables III and IV respectively for a 2 bit TDRA field. In this example N_{CB}=2, and when the e-Type 3 CB is triggered, the UE uses the second TDRA table if the gNB wishes to schedule a PDSCH. Here, the TDRA index would also indicate one of N_{CB}=2 e-Type 3 CBs to use. It should be appreciated that in this arrangement, N_{CB} can be equal to the number of TDRA entries, i.e. N_{CB}=4, or some CBs of the N_{CB} CBs may appear more frequently among the TDRA entries than other CBs. It should also be observed that the S and L parameters in the first TDRA table and second TDRA table do not need to be the same.

TABLE III
first TDRA table used when e-Type 3 CB is not triggered

| TDRA | Symbol | PDSCH |
|---|---|---|
| Index | Offset, S | Duration, L |
| 00 | 1 | 12 |
| 01 | 4 | 8 |
| 10 | 2 | 8 |
| 11 | 5 | 6 |

TABLE IV
second TDRA table used when e-Type 3 CB is triggered

| TDRA | Symbol | PDSCH | e-Type 3 |
|---|---|---|---|
| Index | Offset, S | Duration, L | CB Index |
| 00 | 3 | 10 | 0 |
| 01 | 4 | 8 | 1 |
| 10 | 2 | 8 | 0 |
| 11 | 2 | 8 | 1 |

In another such arrangement of embodiments of the present technique where one or more scheduling parameters of the PDSCH may be reduced to a smaller set of values, the reduction in a PDSCH scheduling parameter is effected by reducing it to a single possible value. That is, a default MCS, HPN or TDRA is/are used if the triggering DCI triggers an e-Type 3 CB and schedules a PDSCH, and so the bits used for these parameters can be reused to indicate one of N_{CB} e-Type 3 CBs. In other words, all of the bits in at least one of the groups of bits are used for the selection of the selected codebook, and wherein a default value of the at least one scheduling parameter indicated by the at least one of the groups of bits is to be used. The default values here may be RRC configured.

In an implementation using default PDSCH scheduling parameters, a default PDSCH may be used. That is, all of the bits required to indicate the scheduling parameters can be reused for the indication of an e-Type 3 CB. In this implementation N_{CB} can be equal to M_{CB}.

It should be appreciated that the reduction in PDSCH scheduling parameters in the previously described arrangements of embodiments can be combined. For example, the MCS can be reduced from 5 bits to 3 bits while the HPN may be reduced from 4 bits to 3 bits, thereby giving a total of 3 bits to be used for indicating one of N_{CB}=8 e-Type 3 CBs.

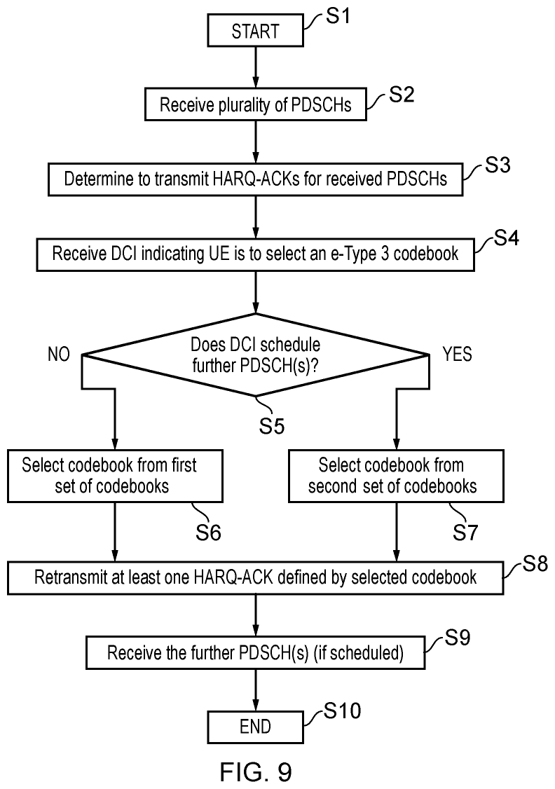

FIG. 9 shows a flow diagram illustrating an example process of communications in a communications system in accordance with embodiments of the present technique. The process shown by FIG. 9 is a method of operating a communications device configured to transmit signals to and/or to receive signals from a wireless communications network (e.g. to or from an infrastructure equipment of the wireless communications network).

The method begins in step S1. The method comprises, in step S2, receiving, from the wireless communications network, a plurality of downlink data signals. In step S3, the process comprises determining that the communications device is to transmit, to the wireless communications network, for each of the downlink data signals, one of a plurality of feedback signals indicating whether or not the downlink data signal was successfully received. In step S4, the method comprises receiving, from the wireless communications network, a downlink control signal indicating that the communications device is to select a codebook comprising at least one of the plurality of feedback signals for retransmission to the wireless communications network. Then, in step S5, the process comprises determining, based on the downlink control signal, whether at least one further downlink data signal is scheduled to be received by the communications device from the wireless communications network in accordance with a plurality of scheduling parameters indicated by the downlink control signalling. The method in step S6 comprises, if it was determined in step S5 that no further downlink data signals are scheduled, selecting the codebook from a first set of codebooks. On the other hand, if it was determined in step S5 that the at least one further downlink data signal is scheduled, the process comprises in step S7 selecting the codebook from a second set of codebooks. Then, in step S8, the process comprises retransmitting, to the wireless communications network, the at least one feedback signal defined by the selected codebook. Optionally, if it was determined in step S5 that the at least one further downlink data signal is scheduled, the method, in step S9, may comprise receiving the at least one further downlink data signal from the wireless communications network (e.g. from the infrastructure equipment 82) in accordance with the plurality of scheduling parameters indicated by the downlink control signalling. It should be appreciated by those skilled in the art that step S9, if it occurs, may in at least some implementations of the method shown by FIG. 9 start before step S8. The process ends in step S10.

Those skilled in the art would appreciate that the method shown by FIG. 9 may be adapted in accordance with embodiments of the present technique. For example, other intermediate steps may be included in this method, or the steps may be performed in any logical order. Though embodiments of the present technique have been described largely by way of the example communications system shown in FIG. 8, it would be clear to those skilled in the art that they could be equally applied to other systems to those described herein.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:

Paragraph 1. A method of operating a communications device configured to transmit signals to and/or to receive signals from a wireless communications network via a wireless radio interface provided by the wireless communications network, the method comprising
receiving, from the wireless communications network, a plurality of downlink data signals,
determining that the communications device is to transmit, to the wireless communications network, for each of the downlink data signals, one of a plurality of feedback signals indicating whether or not the downlink data signal was successfully received,
receiving, from the wireless communications network, a downlink control signal indicating that the communications device is to select a codebook comprising at least one of the plurality of feedback signals for retransmission to the wireless communications network,
determining, based on the downlink control signal, whether at least one further downlink data signal is scheduled to be received by the communications device from the wireless communications network in accordance with a plurality of scheduling parameters indicated by the downlink control signalling, and either
selecting, if the communications device determines that no further downlink data signals are scheduled, the codebook from a first set of codebooks, or
selecting, if the communications device determines that the at least one further downlink data signal is scheduled, the codebook from a second set of codebooks, and subsequently
retransmitting, to the wireless communications network, the at least one feedback signal defined by the selected codebook.

Paragraph 2. A method according to Paragraph 1, wherein the first set of codebooks comprises a greater number of codebooks than the second set of codebooks.

Paragraph 3. A method according to Paragraph 2, wherein the second set of codebooks is a subset of the first set of codebooks.

Paragraph 4. A method according to any of Paragraphs 1 to 3, wherein the downlink control signal comprises a bit that has a value that indicates that the communications device is to select the codebook and to retransmit the at least one feedback signal defined by the selected codebook.

Paragraph 5. A method according to any of Paragraphs 1 to 4, wherein the downlink control signal comprises a bit field that indicates whether or not the at least one further downlink data signal is scheduled.

Paragraph 6. A method according to Paragraph 5, wherein if all the bits of the bit field are the same, the bit field indicates that no further downlink data signals are scheduled and therefore that the selected codebook is to be selected from the first set of codebooks.

Paragraph 7. A method according to Paragraph 5 or Paragraph 6, wherein if the bits of the bit field are not all the same, the bit field indicates resources of the wireless radio interface in which the at least one further downlink data signal is scheduled, and therefore that the selected codebook is to be selected from the second set of codebooks.

Paragraph 8. A method according to any of Paragraphs 1 to 7, wherein the second set of codebooks comprises only a single codebook, the single codebook being a default codebook.

Paragraph 9. A method according to Paragraph 8, wherein the first set of codebooks comprises a plurality of codebooks, wherein one of the codebooks is the default codebook.

Paragraph 10. A method according to Paragraph 9, wherein the default codebook comprises a higher number of feedback signals than the other codebooks of the first set of codebooks.

Paragraph 11. A method according to Paragraph 10, wherein the method comprises determining that the codebook with the higher number of feedback signals than the other codebooks of the first set of codebooks is the default codebook.

Paragraph 12. A method according to any of Paragraphs 9 to 11, wherein each of the codebooks of the first set of codebooks are associated with a unique index value, and wherein the default codebook is associated with a first of the unique index values.

Paragraph 13. A method according to any of Paragraphs 8 to 12, wherein the default codebook comprises all of the plurality of feedback signals.

Paragraph 14. A method according to any of Paragraphs 1 to 13, wherein the downlink control signal indicates that the at least one further downlink data signal is scheduled, and therefore that the selected codebook is part of the second set of codebooks, and wherein the second set of codebooks comprises a plurality of codebooks.

Paragraph 15. A method according to Paragraph 14, wherein the selected codebook is selected by the communications device from among the plurality of codebooks based on at least one condition of the plurality of feedback signals.

Paragraph 16. A method according to Paragraph 14 or Paragraph 15, wherein the downlink control signal comprises a plurality of groups of one or more bits, each group of bits indicating one of the plurality of scheduling parameters in accordance with which the at least one further downlink data signal is scheduled to be received by the communications device, and
wherein the selected codebook is selected by the communications device from among the plurality of codebooks based on a value of at least one bit of one of the groups of bits, the scheduling parameter indicated by the one of the groups of bits therefore being indicated by a reduced number of bits.

Paragraph 17. A method according to Paragraph 16, wherein the scheduling parameter indicated by the reduced number of bits is a modulation and coding scheme.

Paragraph 18. A method according to Paragraph 16 or Paragraph 17, wherein the scheduling parameter indicated by the reduced number of bits is a Hybrid Automatic Repeat Request, HARQ, process number.

Paragraph 19. A method according to any of Paragraphs 16 to 18, wherein the scheduling parameter indicated by the reduced number of bits is a Time Domain Resource Assignment, TDRA.

Paragraph 20. A method according to any of Paragraphs 16 to 19, wherein all of the bits in at least one of the groups of bits are used for the selection of the selected codebook, and wherein a default value of the at least one scheduling parameter indicated by the at least one of the groups of bits is to be used.

Paragraph 21. A method according to any of Paragraphs 14 to 20, wherein the selected codebook is selected by the communications device from among the plurality of codebooks based on an index value of a TDRA indicated from among a plurality of TDRAs that are each associated with a unique index value, the TDRA being one of the plurality of scheduling parameters in accordance with which the at least one further downlink data signal is scheduled to be received by the communications device.

Paragraph 22. A method according to any of Paragraphs 14 to 21, wherein the selected codebook is selected by the communications device from among the plurality of codebooks based on a TDRA being indicated from among a first plurality of TDRAs that are indicated when the communications device is not required to retransmit any feedback signals, the first plurality of TDRAs being different to a second plurality of TDRAs that are indicated when the communications device is required to retransmit one or more feedback signals, the TDRA being one of the plurality of scheduling parameters in accordance with which the at least one further downlink data signal is scheduled to be received by the communications device.

Paragraph 23. A communications device comprising
transceiver circuitry configured to transmit signals to and/or to receive signals from a wireless communications network via a wireless radio interface provided by the wireless communications network, and
controller circuitry configured in combination with the transceiver circuitry
to receive, from the wireless communications network, a plurality of downlink data signals,
to determine that the communications device is to transmit, to the wireless communications network, for each of the downlink data signals, one of a plurality of feedback signals indicating whether or not the downlink data signal was successfully received,
to receive, from the wireless communications network, a downlink control signal indicating that the communications device is to select a codebook comprising at least one of the plurality of feedback signals for retransmission to the wireless communications network,
to determine, based on the downlink control signal, whether at least one further downlink data signal is scheduled to be received by the communications device from the wireless communications network in accordance with a plurality of scheduling parameters indicated by the downlink control signalling, and either
to select, if the communications device determines that no further downlink data signals are scheduled, the codebook from a first set of codebooks, or
to select, if the communications device determines that the at least one further downlink data signal is scheduled, the codebook from a second set of codebooks, and subsequently
to retransmit, to the wireless communications network, the at least one feedback signal defined by the selected codebook.

Paragraph 24. Circuitry for a communications device comprising
transceiver circuitry configured to transmit signals to and/or to receive signals from a wireless communications network via a wireless radio interface provided by the wireless communications network, and
controller circuitry configured in combination with the transceiver circuitry
to receive, from the wireless communications network, a plurality of downlink data signals,
to determine that the transceiver circuitry is to transmit, to the wireless communications network, for each of the downlink data signals, one of a plurality of feedback signals indicating whether or not the downlink data signal was successfully received,
to receive, from the wireless communications network, a downlink control signal indicating that the communications device is to select a codebook comprising at least one of the plurality of feedback signals for retransmission to the wireless communications network,
to determine, based on the downlink control signal, whether at least one further downlink data signal is scheduled to be received by the transceiver circuitry from the wireless communications network in accordance with a plurality of scheduling parameters indicated by the downlink control signalling, and either
to select, if the communications device determines that no further downlink data signals are scheduled, the codebook from a first set of codebooks, or
to select, if the communications device determines that the at least one further downlink data signal is scheduled, the codebook from a second set of codebooks, and subsequently
to retransmit, to the wireless communications network, the at least one feedback signal defined by the selected codebook.

Paragraph 25. A method of operating an infrastructure equipment forming part of a wireless communications network, the infrastructure equipment being configured to transmit signals to and/or to receive signals from a communications device via a wireless radio interface provided by the infrastructure equipment, the method comprising
transmitting, to the communications device, a plurality of downlink data signals,
determining that the infrastructure equipment is to receive, from the communications device, for each of the downlink data signals, one of a plurality of feedback signals indicating whether or not the downlink data signal was successfully received,
determining that the communications device is to transmit at least one of the plurality of feedback signals to the infrastructure equipment,
determining whether the infrastructure equipment is to transmit at least one further downlink data signal to the communications device in accordance with a plurality of scheduling parameters indicated by the downlink control signalling,
transmitting, to the communications device, a downlink control signal indicating that the communications device is to select a codebook comprising the at least one of the plurality of feedback signals for retransmission to the infrastructure equipment, wherein the downlink control signal further comprises, if the infrastructure equipment determines that it is to transmit at least one further downlink data signal to the communications device, an indication that the at least one further downlink data signal is scheduled, and either
determining that the communications device will select, if no further downlink data signals are scheduled, the codebook from a first set of codebooks, or
determining that the communications device will select, if the at least one further downlink data signal is scheduled, the codebook from a second set of codebooks, and subsequently
receiving, from the communications device, a retransmission of the at least one feedback signal defined by the selected codebook.

Paragraph 26. A method according to Paragraph 25, wherein the first set of codebooks comprises a greater number of codebooks than the second set of codebooks.

Paragraph 27. A method according to Paragraph 26, wherein the second set of codebooks is a subset of the first set of codebooks.

Paragraph 28. A method according to any of Paragraphs 25 to 27, wherein the downlink control signal comprises a bit that has a value that indicates that the communications device is to select the codebook and to retransmit the at least one feedback signal defined by the selected codebook.

Paragraph 29. A method according to any of Paragraphs 25 to 28, wherein the downlink control signal comprises a bit field that indicates whether or not the at least one further downlink data signal is scheduled.

Paragraph 30. A method according to Paragraph 29, wherein if all the bits of the bit field are the same, the bit field indicates that no further downlink data signals are scheduled, and therefore the method comprises determining that the communications device will select the selected codebook from the first set of codebooks.

Paragraph 31. A method according to Paragraph 29 or Paragraph 30, wherein if the bits of the bit field are not all the same, the bit field indicates resources of the wireless radio interface in which the at least one further downlink data signal is scheduled, and therefore the method comprises determining that the communications device will select the selected codebook from the second set of codebooks.

Paragraph 32. A method according to any of Paragraphs 25 to 31, wherein the second set of codebooks comprises only a single codebook, the single codebook being a default codebook.

Paragraph 33. A method according to Paragraph 32, wherein the first set of codebooks comprises a plurality of codebooks, wherein one of the codebooks is the default codebook.

Paragraph 34. A method according to Paragraph 33, wherein the default codebook comprises a higher number of feedback signals than the other codebooks of the first set of codebooks.

Paragraph 35. A method according to Paragraph 33 or Paragraph 34, wherein each of the codebooks of the first set of codebooks are associated with a unique index value, and wherein the default codebook is associated with a first of the unique index values.

Paragraph 36. A method according to any of Paragraphs 32 to 35, wherein the default codebook comprises all of the plurality of feedback signals.

Paragraph 37. A method according to any of Paragraphs 25 to 36, wherein the downlink control signal indicates that the at least one further downlink data signal is scheduled, and therefore the method comprises determining that the communications device will select the selected codebook from the second set of codebooks, and wherein the second set of codebooks comprises a plurality of codebooks.

Paragraph 38. A method according to Paragraph 37, wherein the method comprises determining that the communications device will select the selected codebook is from among the plurality of codebooks based on at least one condition of the plurality of feedback signals.

Paragraph 39. A method according to Paragraph 37 or Paragraph 38, wherein the downlink control signal comprises a plurality of groups of one or more bits, each group of bits indicating one of the plurality of scheduling parameters in accordance with which the at least one further downlink data signal is scheduled to be received by the communications device, and the method comprises
determining that the communications device will select the selected codebook from among the plurality of codebooks based on a value of at least one bit of one of the groups of bits, the scheduling parameter indicated by the one of the groups of bits therefore being indicated by a reduced number of bits.

Paragraph 40. A method according to Paragraph 39, wherein the scheduling parameter indicated by the reduced number of bits is a modulation and coding scheme.

Paragraph 41. A method according to Paragraph 39 or Paragraph 40, wherein the scheduling parameter indicated by the reduced number of bits is a Hybrid Automatic Repeat Request, HARQ, process number.

Paragraph 42. A method according to any of Paragraphs 39 to 41, wherein the scheduling parameter indicated by the reduced number of bits is a Time Domain Resource Assignment, TDRA.

Paragraph 43. A method according to any of Paragraphs 39 to 42, wherein all of the bits in at least one of the groups of bits are used for the selection of the selected codebook, and wherein a default value of the at least one scheduling parameter indicated by the at least one of the groups of bits is to be used.

Paragraph 44. A method according to any of Paragraphs 37 to 43, wherein the method comprises determining that the communications device will select the selected codebook from among the plurality of codebooks based on an index value of a TDRA indicated from among a plurality of TDRAs that are each associated with a unique index value, the TDRA being one of the plurality of scheduling parameters in accordance with which the at least one further downlink data signal is scheduled to be received by the communications device.

Paragraph 45. A method according to any of Paragraphs 37 to 44, wherein the method comprises
indicating a TDRA to the communications device, and
determining that the communications device will select the selected codebook from among the plurality of codebooks based on the TDRA being indicated from among a first plurality of TDRAs that are indicated when the communications device is not required to retransmit any feedback signals, the first plurality of TDRAs being different to a second plurality of TDRAs that are indicated when the communications device is required to retransmit one or more feedback signals, the TDRA being one of the plurality of scheduling parameters in accordance with which the at least one further downlink data signal is scheduled to be received by the communications device.

Paragraph 46. An infrastructure equipment forming part of a wireless communications network, the infrastructure equipment comprising
transceiver circuitry configured to transmit signals to and/or to receive signals from a communications device via a wireless radio interface provided by the infrastructure equipment, and
controller circuitry configured in combination with the transceiver circuitry
to transmit, to the communications device, a plurality of downlink data signals,
to determine that the infrastructure equipment is to receive, from the communications device, for each of the downlink data signals, one of a plurality of feedback signals indicating whether or not the downlink data signal was successfully received,
to determine that the communications device is to transmit at least one of the plurality of feedback signals to the infrastructure equipment,
to determine whether the infrastructure equipment is to transmit at least one further downlink data signal to the communications device in accordance with a plurality of scheduling parameters indicated by the downlink control signalling,
to transmit, to the communications device, a downlink control signal indicating that the communications device is to select a codebook comprising the at least one of the plurality of feedback signals for retransmission to the infrastructure equipment, wherein the downlink control signal further indicates, if the infrastructure equipment determines that it is to transmit at least one further downlink data signal to the communications device, an indication that the at least one further downlink data signal is scheduled, and either
to determine that the communications device will select, if no further downlink data signals are scheduled, the codebook from a first set of codebooks, or
to determine that the communications device will select, if the at least one further downlink data signal is scheduled, the codebook from a second set of codebooks, and subsequently
to receive, from the communications device, a retransmission of the at least one feedback signal defined by the selected codebook.

Paragraph 47. Circuitry for an infrastructure equipment forming part of a wireless communications network, the infrastructure equipment comprising
transceiver circuitry configured to transmit signals to and/or to receive signals from a communications device via a wireless radio interface provided by the infrastructure equipment, and
controller circuitry configured in combination with the transceiver circuitry
to transmit, to the communications device, a plurality of downlink data signals,
to determine that the infrastructure equipment is to receive, from the communications device, for each of the downlink data signals, one of a plurality of feedback signals indicating whether or not the downlink data signal was successfully received,
to determine that the communications device is to transmit at least one of the plurality of feedback signals to the infrastructure equipment,
to determine whether the infrastructure equipment is to transmit at least one further downlink data signal to the communications device in accordance with a plurality of scheduling parameters indicated by the downlink control signalling,
to transmit, to the communications device, a downlink control signal indicating that the communications device is to select a codebook comprising the at least one of the plurality of feedback signals for retransmission to the infrastructure equipment, wherein the downlink control signal further indicates, if the infrastructure equipment determines that it is to transmit at least one further downlink data signal to the communications device, an indication that the at least one further downlink data signal is scheduled, and either
to determine that the communications device will select, if no further downlink data signals are scheduled, the codebook from a first set of codebooks, or
to determine that the communications device will select, if the at least one further downlink data signal is scheduled, the codebook from a second set of codebooks, and subsequently
to receive, from the communications device, a retransmission of the at least one feedback signal defined by the selected codebook.

Paragraph 48. A wireless communications system comprising a communications device according to Paragraph 22 and an infrastructure equipment according to Paragraph 46.

Paragraph 49. A computer program comprising instructions which, when loaded onto a computer, cause the computer to perform a method according to any of Paragraphs 1 to 22 or Paragraph 25 to 45.

Paragraph 50. A non-transitory computer-readable storage medium storing a computer program according to Paragraph 49.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] TR 38.913, “Study on Scenarios and Requirements for Next Generation Access Technologies (Release 14)”, third Generation Partnership Project, v14.3.0.
[3] RP-190726, “Physical layer enhancements for NR ultra-reliable and low latency communication (URLLC)”, Huawei, HiSilicon, RAN #83.
[4] RP-201310, “Revised WID: Enhanced Industrial Internet of Things (IoT) and ultra-reliable and low latency communication (URLLC) support for NR,” Nokia, Nokia Shanghai Bell, RAN #88e.
[5]R1-2108547, “Final moderator summary on HARQ-ACK feedback enhancements for NR Rel-17 URLLC/IIoT,” Moderator (Nokia), RAN1 #106e.
[6] European patent application number EP21188964.7, Sony Group Corporation.

1. A method of operating a communications device configured to transmit signals to and/or to receive signals from a wireless communications network via a wireless radio interface provided by the wireless communications network, the method comprising
receiving, from the wireless communications network, a plurality of downlink data signals,
determining that the communications device is to transmit, to the wireless communications network, for each of the downlink data signals, one of a plurality of feedback signals indicating whether or not the downlink data signal was successfully received,
receiving, from the wireless communications network, a downlink control signal indicating that the communications device is to select a codebook comprising at least one of the plurality of feedback signals for retransmission to the wireless communications network,
determining, based on the downlink control signal, whether at least one further downlink data signal is scheduled to be received by the communications device from the wireless communications network in accordance with a plurality of scheduling parameters indicated by the downlink control signalling, and either
selecting, if the communications device determines that no further downlink data signals are scheduled, the codebook from a first set of codebooks, or
selecting, if the communications device determines that the at least one further downlink data signal is scheduled, the codebook from a second set of codebooks, and subsequently
retransmitting, to the wireless communications network, the at least one feedback signal defined by the selected codebook.

2. A method according to claim 1, wherein the first set of codebooks comprises a greater number of codebooks than the second set of codebooks.

3. A method according to claim 2, wherein the second set of codebooks is a subset of the first set of codebooks.

4. A method according to claim 1, wherein the downlink control signal comprises a bit that has a value that indicates that the communications device is to select the codebook and to retransmit the at least one feedback signal defined by the selected codebook.

5. A method according to claim 1, wherein the downlink control signal comprises a bit field that indicates whether or not the at least one further downlink data signal is scheduled.

6. A method according to claim 5, wherein if all the bits of the bit field are the same, the bit field indicates that no further downlink data signals are scheduled and therefore that the selected codebook is to be selected from the first set of codebooks.

7. A method according to claim 5, wherein if the bits of the bit field are not all the same, the bit field indicates resources of the wireless radio interface in which the at least one further downlink data signal is scheduled, and therefore that the selected codebook is to be selected from the second set of codebooks.

8. A method according to claim 1, wherein the second set of codebooks comprises only a single codebook, the single codebook being a default codebook.

9. A method according to claim 8, wherein the first set of codebooks comprises a plurality of codebooks, wherein one of the codebooks is the default codebook.

10. A method according to claim 9, wherein the default codebook comprises a higher number of feedback signals than the other codebooks of the first set of codebooks.

11. A method according to claim 10, wherein the method comprises determining that the codebook with the higher number of feedback signals than the other codebooks of the first set of codebooks is the default codebook.

12. A method according to claim 9, wherein each of the codebooks of the first set of codebooks are associated with a unique index value, and wherein the default codebook is associated with a first of the unique index values.

13. A method according to claim 8, wherein the default codebook comprises all of the plurality of feedback signals.

14. A method according to claim 1, wherein the downlink control signal indicates that the at least one further downlink data signal is scheduled, and therefore that the selected codebook is part of the second set of codebooks, and wherein the second set of codebooks comprises a plurality of codebooks.

15. A method according to claim 14, wherein the selected codebook is selected by the communications device from among the plurality of codebooks based on at least one condition of the plurality of feedback signals.

16. A method according to claim 14, wherein the downlink control signal comprises a plurality of groups of one or more bits, each group of bits indicating one of the plurality of scheduling parameters in accordance with which the at least one further downlink data signal is scheduled to be received by the communications device, and
wherein the selected codebook is selected by the communications device from among the plurality of codebooks based on a value of at least one bit of one of the groups of bits, the scheduling parameter indicated by the one of the groups of bits therefore being indicated by a reduced number of bits.

17.-20. (canceled)

21. A method according to claim 14, wherein the selected codebook is selected by the communications device from among the plurality of codebooks based on an index value of a TDRA indicated from among a plurality of TDRAs that are each associated with a unique index value, the TDRA being one of the plurality of scheduling parameters in accordance with which the at least one further downlink data signal is scheduled to be received by the communications device.

22. A method according to claim 14, wherein the selected codebook is selected by the communications device from among the plurality of codebooks based on a TDRA being indicated from among a first plurality of TDRAs that are indicated when the communications device is not required to retransmit any feedback signals, the first plurality of TDRAs being different to a second plurality of TDRAs that are indicated when the communications device is required to retransmit one or more feedback signals, the TDRA being one of the plurality of scheduling parameters in accordance with which the at least one further downlink data signal is scheduled to be received by the communications device.

23. (canceled)

24. Circuitry for a communications device comprising
transceiver circuitry configured to transmit signals to and/or to receive signals from a wireless communications network via a wireless radio interface provided by the wireless communications network, and
controller circuitry configured in combination with the transceiver circuitry
to receive, from the wireless communications network, a plurality of downlink data signals,
to determine that the transceiver circuitry is to transmit, to the wireless communications network, for each of the downlink data signals, one of a plurality of feedback signals indicating whether or not the downlink data signal was successfully received,
to receive, from the wireless communications network, a downlink control signal indicating that the communications device is to select a codebook comprising at least one of the plurality of feedback signals for retransmission to the wireless communications network,
to determine, based on the downlink control signal, whether at least one further downlink data signal is scheduled to be received by the transceiver circuitry from the wireless communications network in accordance with a plurality of scheduling parameters indicated by the downlink control signalling, and either
to select, if the communications device determines that no further downlink data signals are scheduled, the codebook from a first set of codebooks, or
to select, if the communications device determines that the at least one further downlink data signal is scheduled, the codebook from a second set of codebooks, and subsequently
to retransmit, to the wireless communications network, the at least one feedback signal defined by the selected codebook.

25.-46. (canceled)

47. Circuitry for an infrastructure equipment forming part of a wireless communications network, the infrastructure equipment comprising
transceiver circuitry configured to transmit signals to and/or to receive signals from a communications device via a wireless radio interface provided by the infrastructure equipment, and
controller circuitry configured in combination with the transceiver circuitry
to transmit, to the communications device, a plurality of downlink data signals,
to determine that the infrastructure equipment is to receive, from the communications device, for each of the downlink data signals, one of a plurality of feedback signals indicating whether or not the downlink data signal was successfully received,
to determine that the communications device is to transmit at least one of the plurality of feedback signals to the infrastructure equipment,
to determine whether the infrastructure equipment is to transmit at least one further downlink data signal to the communications device in accordance with a plurality of scheduling parameters indicated by the downlink control signalling,
to transmit, to the communications device, a downlink control signal indicating that the communications device is to select a codebook comprising the at least one of the plurality of feedback signals for retransmission to the infrastructure equipment, wherein the downlink control signal further indicates, if the infrastructure equipment determines that it is to transmit at least one further downlink data signal to the communications device, an indication that the at least one further downlink data signal is scheduled, and either
to determine that the communications device will select, if no further downlink data signals are scheduled, the codebook from a first set of codebooks, or
to determine that the communications device will select, if the at least one further downlink data signal is scheduled, the codebook from a second set of codebooks, and subsequently
to receive, from the communications device, a retransmission of the at least one feedback signal defined by the selected codebook.

48.-50. (canceled)
